(19) United States
(12) Patent Application Publication
(10) Pub. No.: US 2012/0109519 A1
(43) Pub. Date: May 3, 2012

(54) SYSTEM AND METHOD FOR ROUTING BEV TO CHARGING STATION

(75) Inventor: Robert M. Uyeki, Torrance, CA (US)

(73) Assignee: Honda Motor Co., Ltd.

(21) Appl. No.: 12/912,806

(22) Filed: Oct. 27, 2010

(51) Int. Cl. G01C 21/26; G01C 21/34

(52) U.S. Cl. 701/439; 701/426

(57) ABSTRACT

A battery electric vehicle (BEV) routing apparatus and methods are presented for routing to a charging station, in which a vehicle navigation system obtains current utilization and compatibility information from a live database and uses this to selectively route the vehicle to a charging station having available chargers compatible with the vehicle.

### BACKGROUND

The present disclosure relates generally to battery electric vehicles (BEVs), and to navigation systems thereof for providing routing selections based on user-entered destination information. Because electric vehicles (EVs) have only recently been introduced in mainstream market channels, electric vehicle charging infrastructure is limited. Smart Chargers are being developed to manage the electrical load during peak loads in anticipation of the increase in EV usage and the associated impact to the distribution grid. If on-board propulsion or charging facilities are unavailable and the EV presently has a low state of charge (SOC) for the electric propulsion system, the vehicle must be brought to a charging station before the battery is completely depleted to avoid power down events requiring the vehicle to be towed to a charging facility. Many modern vehicles are equipped with on-board navigation systems with global position system (GPS) capabilities. A user enters a desired destination and the navigation system determines a driving route from the current vehicle position to the destination. If a BEV does not have enough stored charge to reach a desired destination, the navigation system can be used to route the vehicle to a charging station location. However, charging equipment is not standardized and a given BEV may not be able to connect to chargers at a given station. Moreover, since electric vehicle battery charging operations are typically lengthy, a currently occupied charging station may not be available for timely use even if the BEV is routed to the station. A need therefore exists for improved vehicle navigation systems and routing techniques for BEVs to facilitate routing the vehicle to charging equipment while mitigating power down situations.

### SUMMARY

Various details of the present disclosure are hereinafter summarized to facilitate a basic understanding, where this summary is not an extensive overview of the disclosure, and is intended neither to identify certain elements of the disclosure, nor to delineate the scope thereof. Rather, the primary purpose of this summary is to present some concepts of the disclosure in a simplified form prior to the more detailed description that is presented hereinafter. The disclosure finds utility in routing battery electric vehicles (BEVs) to a charging station when the vehicle does not have sufficient state of charge (SOC) to reach a desired end destination. A vehicle navigation system in certain embodiments queries an external or on-board database to ascertain information for charging stations within range of the current vehicle SOC. The system obtains charging station information indicating current availability information and vehicle compatibility information for the charging stations, and determines a route to a suitable charging facility. The disclosure is adaptable to the expected development and deployment of smart charging stations (Smart Chargers) and may utilize a live POI database that can periodically query the smart chargers to obtain current charger type/compatibility information, as well as current availability information. In operation of certain embodiments, the BEV navigation system will determine whether the current vehicle SOC is sufficient to get to the currently programmed destination. If not, the navigation system queries the live POI database to ascertain information for charging stations within range of the current vehicle SOC. The system then develops a navigation routing algorithm to route directly to the charge station location.

A battery electric vehicle is provided, including a battery, an inverter and an electric motor forming a propulsion system to drive one or more vehicle wheels for propelling the vehicle. The vehicle also includes a navigation system which obtains charging station data from an on-board or external data store, and uses this and the current vehicle state of charge (SOC) to determine in-range charging station(s) having compatible charging equipment that is/are currently available or expected to be available for charging the vehicle.

In certain embodiments, the navigation system obtains charging station data for a set of stations within range of the vehicle based on the present SOC and determines a set of compatible stations having charging equipment compatible with the vehicle according to the charging station data. From this, the system determines a set of available charging stations that is currently available or expected to be available for charging the vehicle according to the charging station data, and selects one or more of these for route determination.

In some embodiments, moreover, the charging station data provides usage data including a charge start time and a charging vehicle current SOC value for compatible charger equipment, and the navigation system determines whether each compatible charger is either available now, expected to be available soon, or unavailable according to the usage data.

The navigation system is further operative to determine a route for directing the vehicle to a destination location corresponding to the selected charging station. In certain embodiments, the navigation system determines the route to the selected charging station using latitude and longitude information from the charging station data to assist drivers in locating charging facilities that may not be immediately adjacent a street address, such as in a large parking lot.

Further aspects of the disclosure provide a method for determining a route for a battery electric vehicle. The method includes obtaining the present vehicle SOC and a current vehicle location, as well as obtaining charging station data from a data store. One or more selected charging stations are determined or identified which have compatible charging equipment and which are currently available or expected to be available for charging the vehicle using the charging station data and the SOC value. The method further includes determining a vehicle route from the current location to the selected charging station(s) based at least partially on the charging station data and on the present SOC value.

In certain embodiments, the method includes obtaining charging station data for a set of in-range charging stations within range of the vehicle based at least in part on the present SOC and determining a set of compatible in-range charging stations having charging equipment compatible with the vehicle based at least in part on the charging station data. The method in these embodiments also includes determining a set of available stations in the set of compatible in-range charging stations that is currently available or expected to be available for charging the vehicle based on the charging station data, as well as determining the selected charging station or stations from the identified set of available compatible in-range charging stations.

Certain embodiments of the method include obtaining usage data with a charge start time and a charging vehicle current SOC value for compatible charger equipment and determining an availability of each compatible charger as one of available now, available soon, or unavailable based at least in part on the usage data. Certain embodiments of the method include determining the route to the destination location using latitude and longitude information from the charging station data for the selected charging station or stations.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIGS. 1A and 1B illustrate an exemplary battery electric vehicle (BEV) having a navigation system for routing the vehicle to compatible charging stations in accordance with one or more aspects of the present disclosure;

FIG. 2 is a system diagram illustrating exemplary EV charging stations coupled with a central charging station data store accessible by BEVs through wireless communications;

FIGS. 3A and 3B are flow charts illustrating an exemplary BEV routing process in accordance with one or more aspects of the disclosure; and

FIGS. 4-6 are front elevation views illustrating an exemplary user interface display for the BEV navigation system.

### DETAILED DESCRIPTION

One or more embodiments or implementations are hereinafter described in conjunction with the drawings, where like reference numerals are used to refer to like elements throughout, and where the various features are not necessarily drawn to scale.

The disclosure relates to battery electric vehicles and navigation systems and methods therefor in which charging station information is provided in a data store for access by BEV navigation systems to determine charging equipment locations, availability, and compatibility for intelligent routing decisions for charging the vehicle battery. If compatible charging stations are within range, the navigation system recommends one or more charging stations according to the availability and compatibility information and can construct a route for navigation of the BEV to a selected charging station, where the recommendation may take into account the total energy required for a round trip route to the charger location. The disclosure also contemplates use of information regarding expected future availability to enable provision of a recommendation if all in-range charging stations are currently in use.

The disclosed systems and techniques can be employed to improve routing to avoid power down or and to avoid the user being stranded and having to tow the vehicle. In addition, the navigation system may construct the route using latitude and longitude information for the charging station (as opposed to merely street address information) so as to expedite finding a charging station that may be associated with a mall or other large enterprise, to avoid requiring the driver to manually locate the charger within the enterprise.

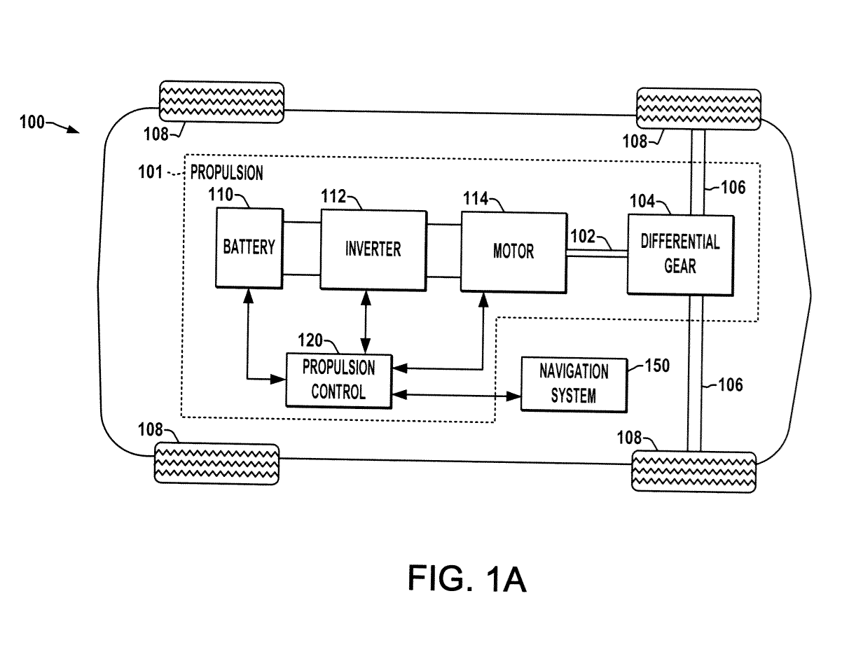

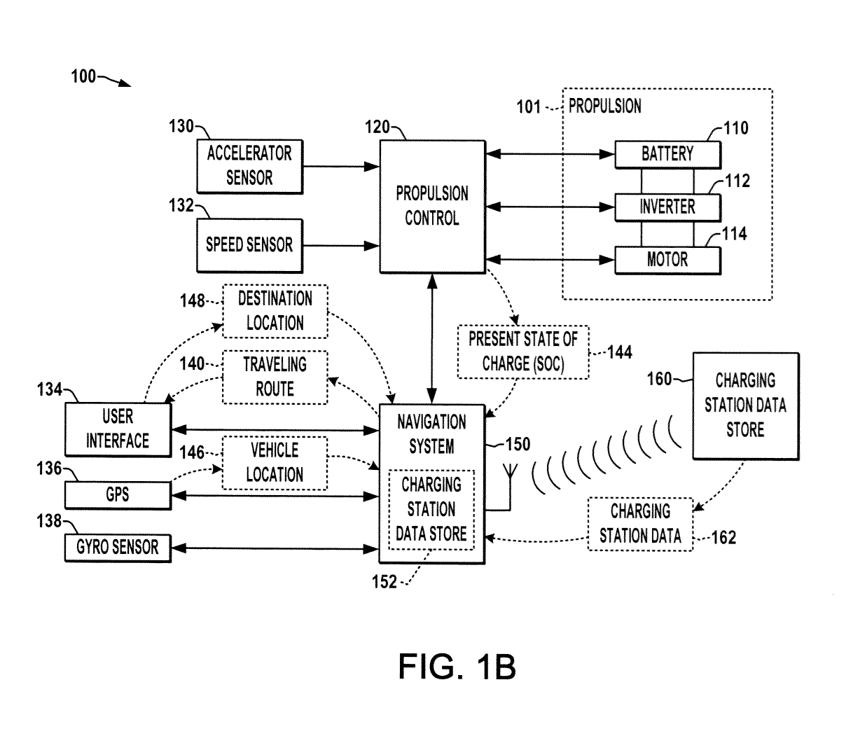

An exemplary battery electric vehicle (BEV) 100 is shown in FIGS. 1A and 1B, which includes an exemplary navigation system 150 for intelligent routing to available and compatible charging stations 202 in accordance with one or more aspects of the disclosure. The BEV 100 includes a propulsion system 101 having an electric motor 114 with a shaft 102, a front wheel drive axle 106 and a differential gear 104 for propelling the vehicle 100 via wheels 108. The propulsion system 101 further includes a battery 110 providing DC current to an inverter 112, which in turn provides AC current to the motor 114 coupled by output shaft 102 with the axle 106 via the differential gear 104. The electric motor 114 drives the shaft 102 to transfer motive power to the differential gear 104, which transmits the motive power to the front wheels 108 by the axle 106 to propel the vehicle 100. One or more additional gears (not shown) may be included. The battery 110 can be any suitable single or multiple battery configuration to supply DC power to the motor 114, for example, a nickel metal hydride, lithium ion, or similar battery, and DC-DC boost circuitry such as a DC-DC converter (not shown) may be included to adjust the DC output of the battery 110 to any level suitable for providing an input to the inverter 112. The inverter 112 receives the DC power directly or indirectly from the battery 110 and converts it to AC voltage to control the drive motor 114 to drive the front wheels 108, and the drive system may include one or more alternative charging means for charging the battery 110, for example, where the motor 114 may operate as a generator during vehicle braking to convert rotational energy from the wheels 108 into electrical energy, with the inverter 112 or other circuitry converting such power to DC current to charge the battery 110.

A propulsion controller 120 controls the inverter 112 according to driver inputs from an accelerator pedal sensor 130, a speed sensor 132, and/or a cruise control function or brake pedal sensor or other sensors (not shown) associated with the vehicle 100, and may include or be operatively coupled with a cruise control system (not shown). The propulsion controller 120 can be implemented as any suitable hardware, processor-executed software, processor-executed firmware, programmable logic, or combinations thereof, operative as any suitable controller or regulator by which the motor 114 and/or the inverter 112 can be controlled according to one or more desired operating values such as speed setpoint(s). The controller 120 obtains a state of charge (SOC) signal or value from the battery 110 or from a controller associated therewith (not shown). The propulsion control unit 120 in certain embodiments calculates an output that the driver requests via the accelerator pedal position sensor 130 or from a cruise control unit (not shown) and determines the vehicle speed from an output signal or value provided by the speed sensor 132. From these, the propulsion controller 120 determines a required driving power for controlling the inverter 112 and thus the motor 114, where the inverter control can include one or both of speed control and/or torque control, as well as other motor control techniques.

The vehicle 100 also includes an on-board navigation unit or system 150 operatively coupled with a user interface 134 that has a display and audio output capability, as well as user input devices such as buttons, touch-screen display controls, voice activation features, etc. The navigation system 150 generally operates according to user-entered destination 148 and preferences information, and interfaces with a GPS system 136 to ascertain the current vehicle position 146. The navigation system 150 may also receive inputs from one or more further sensors, such as a gyro sensor 138 and also communicates with the propulsion controller 120, for instance, to obtain current vehicle speed information and status information regarding the battery 110, the inverter 112, and the motor 114. The navigation system 150 can be implemented as any suitable hardware, processor-executed software, processor-executed firmware, programmable logic, or combinations thereof, and may be integrated with the propulsion control system 120 or with other systems of the vehicle 100.

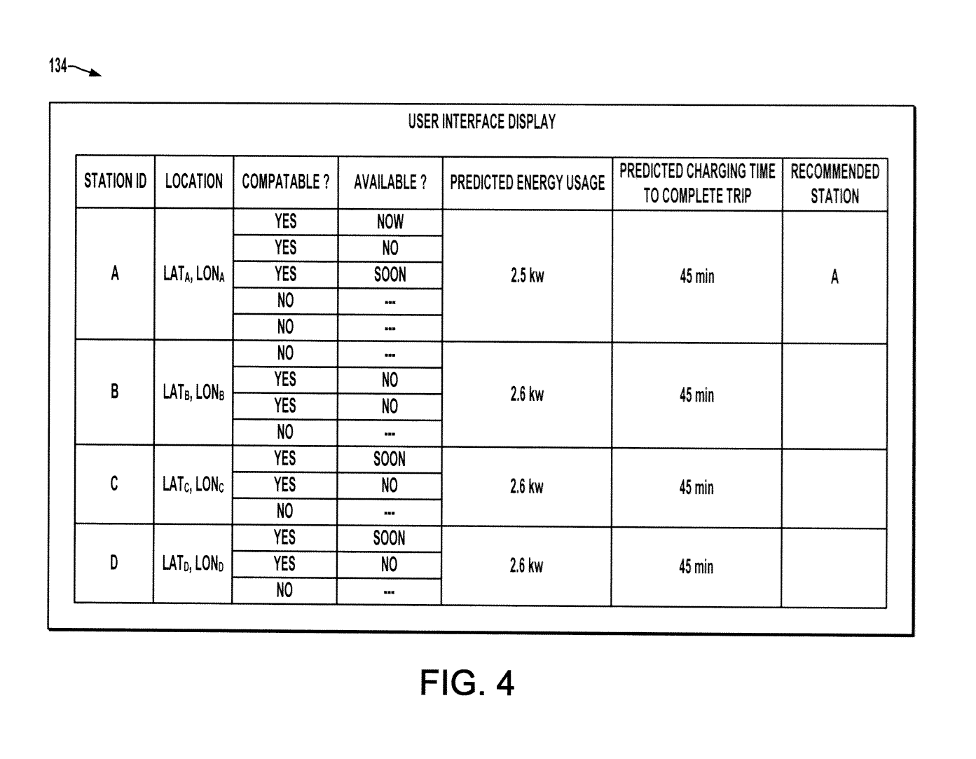

The navigation system 150 in certain embodiments provides a display (e.g., FIGS. 4-6 below) showing a map rendering or other depiction of the current vehicle position on road map with instructions and graphics showing a vehicle route 140 via the user interface 134. The navigation system 150 may also obtain traffic information such as road congestion information, road condition information, and other navigation information from external sources, for instance, via wireless communications apparatus of the vehicle 100 (not shown). In operation, the system 150 can compute and utilize road congestion information for normal route selection and can provide graphical overlays on the user interface display 134 to indicate a congested area on road map data.

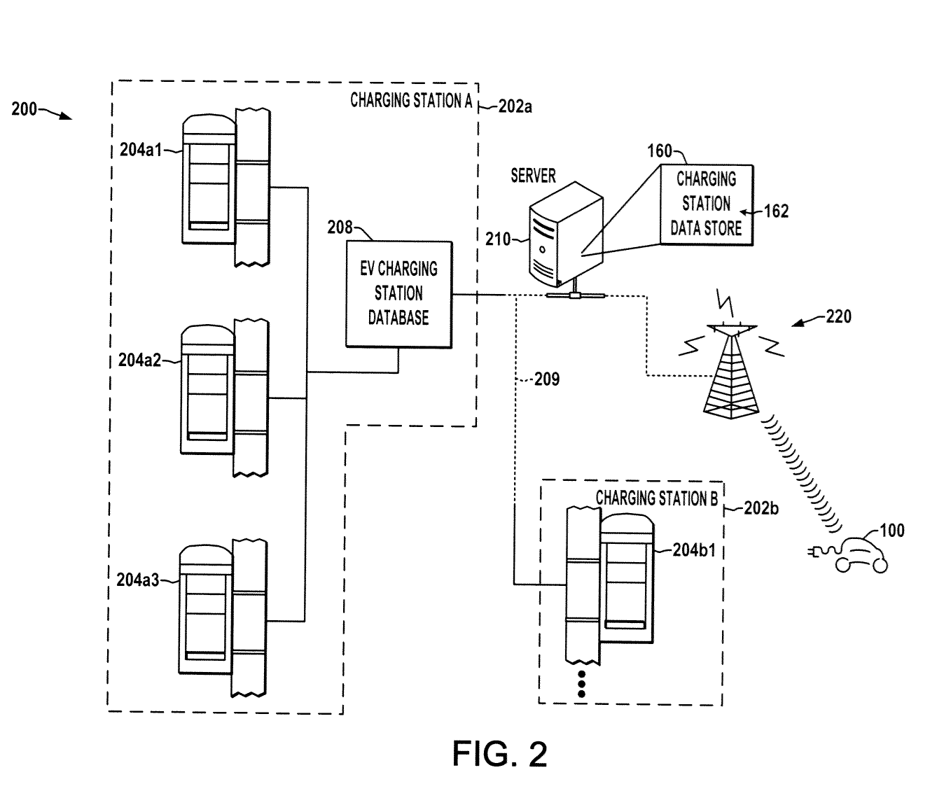

Referring also to FIG. 2, the vehicle navigation system 150 can obtain the present battery state of charge (SOC) value 144 from the propulsion controller 120 and use the SOC 144, the desired destination 148, the current vehicle location 146, and charging station data 162 (FIG. 1B) from an external data store 160 (or from an internal database 152) to provide intelligent routing to charging stations 202 for charging the vehicle battery 110. As seen in FIG. 2, the vehicle 100 at any time may be within range of one or more EV charging stations or charging facilities 202, each having one or more chargers 204. In the example of FIG. 2, a first charging station 202a includes smart chargers 2041a, 204a2 and 204a3 as well as an EV charging station database 208 operatively coupled with the chargers 204a to exchange data therewith.

In certain embodiments, the chargers 204 provide availability and compatibility information to the database 208, such as whether or not the charger 204 is currently being used, start time when a vehicle began charging, the current state of charge (SOC) for the vehicle being charged (or the SOC when the charging began), the amount of charging time left to fully charge the vehicle (or the amount of charge requested by the current customer), and other status information (e.g., out of service, charging capabilities, charger type, etc.). The local charging station database 208 is operatively coupled with a network 209 for interfacing with a server 210 and possible with other charging stations, such as charging station 202b having charger 204b1 in FIG. 2.

The network server 210 maintains a live charging station data store 160 including charging station data 162 obtained/derived from information received from the EV charging station database 208 and/or received directly from one or more chargers 204. The charging station data 162 in certain embodiments may include charger station location, time of last status update, compatibility, availability, ancillary points of interest (POI) near/at the charging station 202, estimated charging time, and optionally information from which future availability may be determined. The server 210 and the data store 160 thereof are accessible to the vehicle 100 via a wireless network interface 220, allowing vehicle navigation systems 150 to communicate with the data store 160 to facilitate intelligent routing to suitable, compatible, and available charging stations 202.

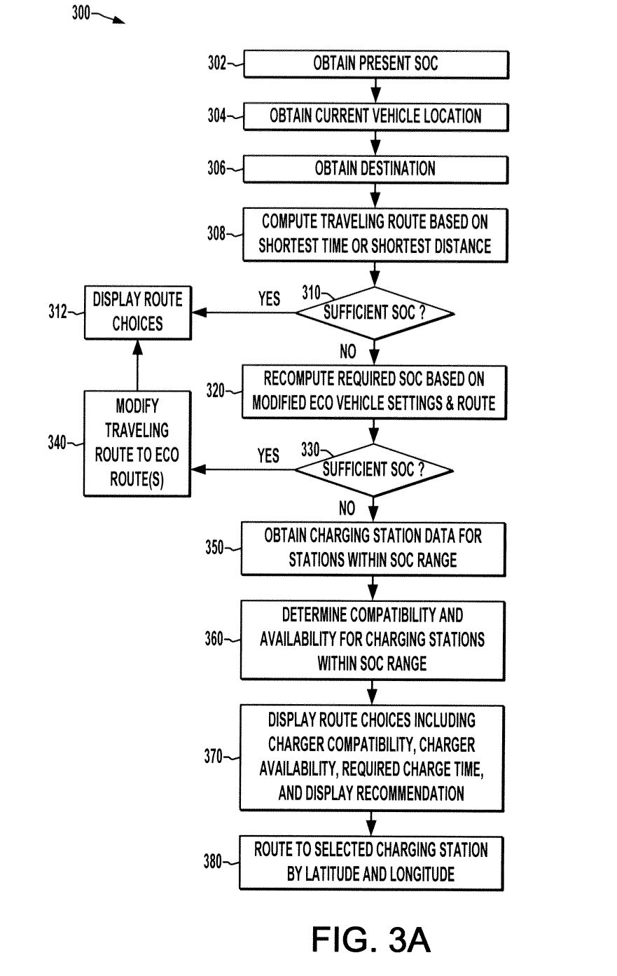

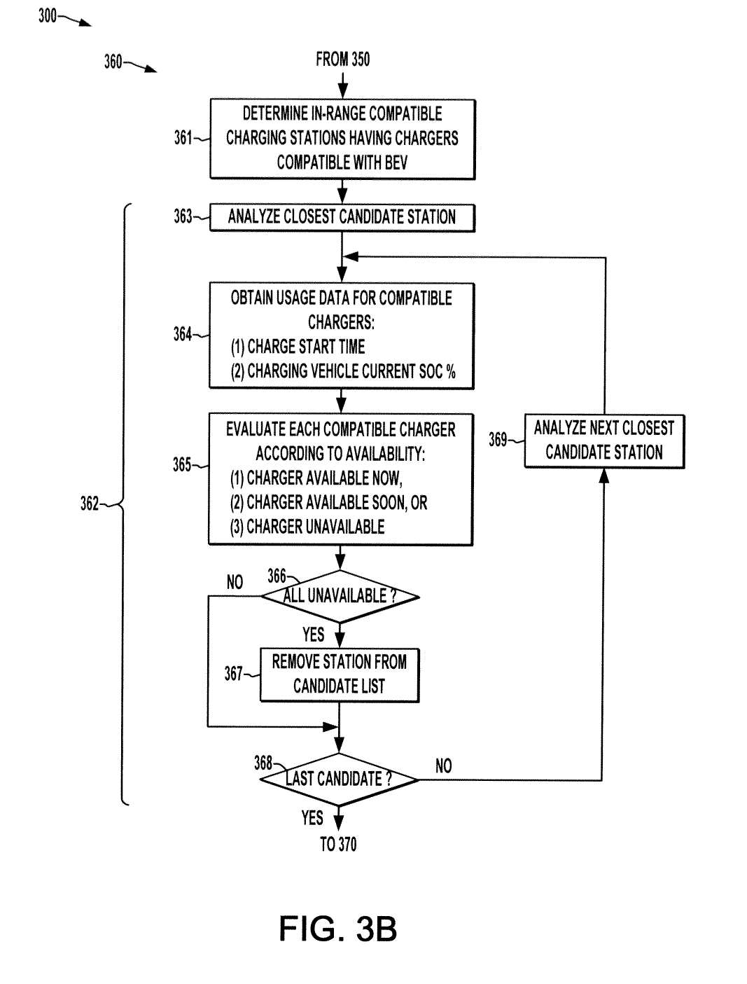

Referring also to FIGS. 3A-6, the navigation system 150 in certain embodiments operates generally according to a route selection process 300 illustrated in FIGS. 3A and 3B. FIGS. 4-6 show exemplary user interface display screens of the user interface 134 during operation of the BEV navigation system for routing the vehicle 100 to a charging station 202. In operation, the navigation system 150 performs a navigation operation to search for or otherwise determine a traveling route 140 extending from the current position 146 to a destination 148 and displays the selected route 140 to the vehicle operator via the user interface 134. FIG. 4 illustrates an example situation in which the system 150 shows a selected route 140 from the current vehicle location 146 to a destination 148a corresponding to a selected charging station 202 (e.g., station 202a in FIG. 2 above). The system 150 may further provide audio driving instructions for the driver to navigate along the selected route 140 without having to visually monitor the displayed map on the interface 134. The navigation features may also provide for current lane monitoring and lane selection using the GPS system 136 to determine the current lane on a multi-lane road, with the display and/or audio output of the user interface 134 indicating to the user the proper (preferred) lane to be in and further indicating when a lane change is needed or preferred to continue on the selected route 140. The navigation system 150, moreover, may include on-board database of road information from which the selected route 140 is derived by any suitable searching algorithms, and/or the system 150 may access external data stores with such information to perform the route determination functions.

In normal operation, the navigation system 150 receives a desired traveling destination 148 from an operator, for instance, using the interface 134, or can obtain the destination from another vehicle system or external system, such as a database of certain points of interest providing destination locations or for emergency routing to a hospital or other location 148. In certain embodiments, the navigation system 150 searches for a traveling route 140 extending from the current vehicle location 146 obtained from the GPS system 136 to the desired destination 148, divides the traveling route into segments, and may associate one of a plurality of traveling modes with each segment of the segmented traveling route 140. In certain embodiments, the navigation system 150 determines multiple candidate routes 140 and displays these to the user via the interface 134, allowing the driver to select a candidate for use in routing to the destination 148.

In accordance with the present disclosure, the navigation system 150 also provides intelligent routing to charging stations 202 using the current vehicle location 146, the current vehicle SOC value 144, and the charging station data 162 obtained from an on-board data store 152 (FIG. 1B above) or from the network data store 160. As shown in FIG. 3A, the system 150 obtains a present state of charge value 144 at 302 (e.g., from the propulsion system 120) which directly indicates (or allows derivation of) the remaining amount of energy stored in the battery 110. The current vehicle location 146 is obtained at 304, for instance, from the GPS system 136. At 306, the system 150 obtains the desired destination location 148, for example, from the user interface 134 or other source. At 308, one or more traveling routes are computed (e.g., by suitable searching algorithm) based on conventional shortest time or shortest distance criteria to direct the vehicle 100 to the desired destination 148.

The system 150 determines at 310 whether the current SOC value 144 for the vehicle 100 meets or exceeds the estimated charge expenditure for the selected route. If so (YES at 310), the system 150 displays the route choices at 312 to the vehicle occupant via the user interface 134. However, if the SOC 144 is insufficient to reach the user destination 148 (NO at 310), the system 150 recomputes the SOC required to make the desired trip at 320 based on a modified economy (ECO) mode of operation with different vehicle settings and possibly by a different route. At 330, the system 150 determines whether the current SOC value 144 meets or exceeds the amount required to traverse the selected ECO route 408. If so (YES at 330), the ECO route is selected and the traveling route is modified at 340 so as to effectively route the vehicle 100 (e.g., through screen prompts and/or audible instructions to the user) to the user's selected destination 148.

If, however, the present SOC 144 is insufficient to reach the destination location 148 using the ECO route and economy settings (or if the user actively chooses to instead route to a charging facility 202, NO at 330), the system 150 obtains charging station data 162 at 350 from the data store 152 or 160 for stations within the current SOC value range. At 360, the system 150 determines at least one of the in-range charging stations 202 having charging equipment 204 that is compatible with the vehicle 100 and is currently available or expected to be available for charging the vehicle 100 based in whole or in part on the charging station data 162 and on the SOC value 144.

At 370, the system 150 determines one or more routes 140 for directing the vehicle 100 from the current vehicle location 146 to the destination location(s) 148 corresponding to the selected charging station(s) 202 based at least in part on the charging station data 162 and on the present state of charge value 144. In certain embodiments, the system 150 displays route choices for user review/selection. FIG. 4 illustrates an exemplary display screen provided via the user interface 134 from the navigation system 150 showing the results of the charging station availability/compatibility operation of the system 150, in which the system 150 displays a number of route choices (e.g., to stations A, B, C, or D), along with identification of one or more recommended stations (station “A” in this example). The display 134 also shows latitude and longitude information for the stations 202, as well as compatibility information (YES or NO), by charger 204, where certain stations 202 include multiple chargers 202. In addition, the display 134 indicates availability information (e.g., NOW, SOON, or NO) for each compatible charger 202. The exemplary screen also shows predicted energy usage amounts as well as predicted charging time information (by charging station 204) for charging to the level needed to complete the trip to the original user specified destination (or alternatively to a fully-charged level).

FIG. 3B illustrates an exemplary embodiment showing the compatibility and availability determination process 360, in which the system 150 uses charging station data 162 at 361 for a set of charging stations 202 within range of the vehicle 100 to determine a set of one or more compatible in-range charging stations 202 that have charging equipment 204 compatible with the vehicle 100. Thereafter at 362, the system 150 determines which of this set is currently available (or is expected to be available soon), thus identifying a set of one or more available compatible in-range charging stations 202 at least partially according to the charging station data 162 as potential candidates for intelligent routing of the vehicle 100 to a charging station 202.

At 363 in FIG. 3B, the system 150 begins with the closest in-range station 202 having at least one compatible charger 204, and obtains corresponding usage data at 364 from the charging station data 162. In the illustrated example, the usage data includes a charge start time and a charging vehicle current SOC value for the analyzed charger 204, if occupied. At 365, the system 150 determines an availability rating or value for the charging equipment 204 based in whole or in part on the usage data. In this case, the system 150 identifies each compatible charger 204 as being either currently available (e.g., available “NOW” in the display rendering of FIG. 4 above), available soon (e.g., “SOON” in FIG. 4), or unavailable (e.g., “NO” in FIG. 4). The system 150 determines at 366 if all the compatible chargers 204 of the analyzed station 202 are unavailable, and if so (YES at 366) removes the station 202 from the set of candidate stations 202 at 367. A determination is made at 368 as to whether this is the last station 202 within the SOC range having compatible chargers 204. If not (NO at 368), the system 150 proceeds to get the data for the next candidate station 202 at 369 and the process 362 proceeds as described above to analyze the availability of remaining stations 202 from the potential candidate set. Once the possible candidates have all been evaluated with respect to availability at 362 (YES at 368 in FIG. 3B), the process 300 returns to 370 in FIG. 3A to display the selected charging station(s) 202 and to generate appropriate route(s) 140 thereto.

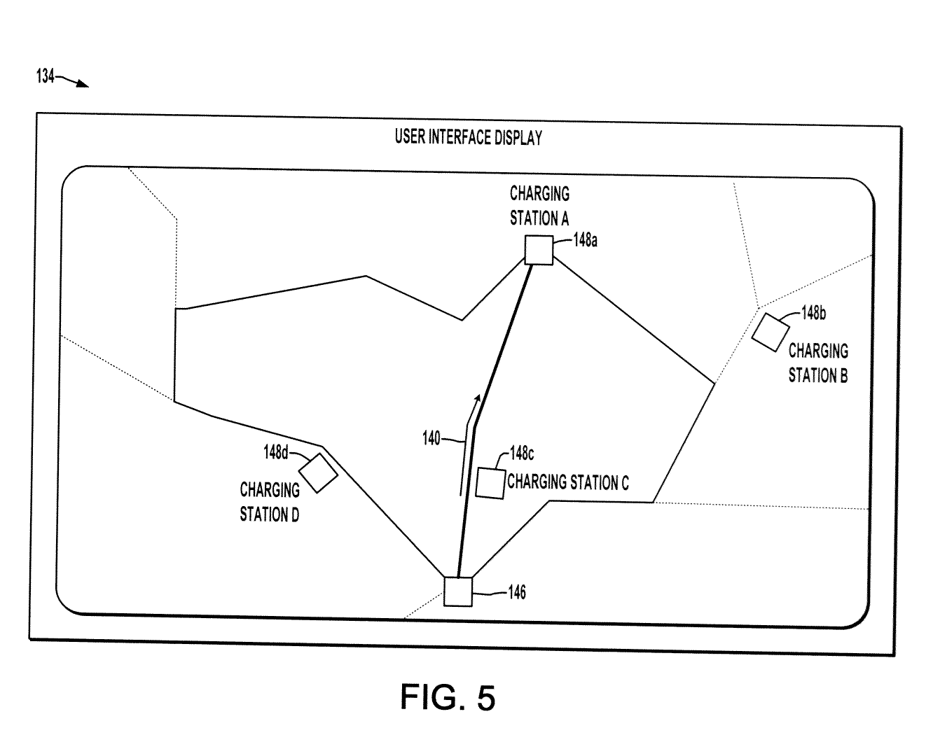

As seen in the example of FIGS. 4 and 5, the system 150 recommends charging station A as the preferred charging destination 148a, since this station has one currently available charger 204, whereas the only other candidate stations B, C, and D (FIG. 4) having compatible chargers 202 are all currently occupied. As shown in FIG. 5, moreover, the recommended charging station A is not the closest to the current vehicle location 146, and indeed the recommended route 140 determined by the system 150 in this situation travels past a closer charging station C. In certain embodiments, the system 150 automatically determines the vehicle route 140 according to the most highly recommended destination 148a, or the system 150 may first prompt the user via the interface 134 to accept this recommendation or to select an alternative (if available). Moreover, the recommendation can include information on other points of interest at or near the charging station 202, such as shopping, markets, coffee shops, etc. to enhance the driver's selection process.

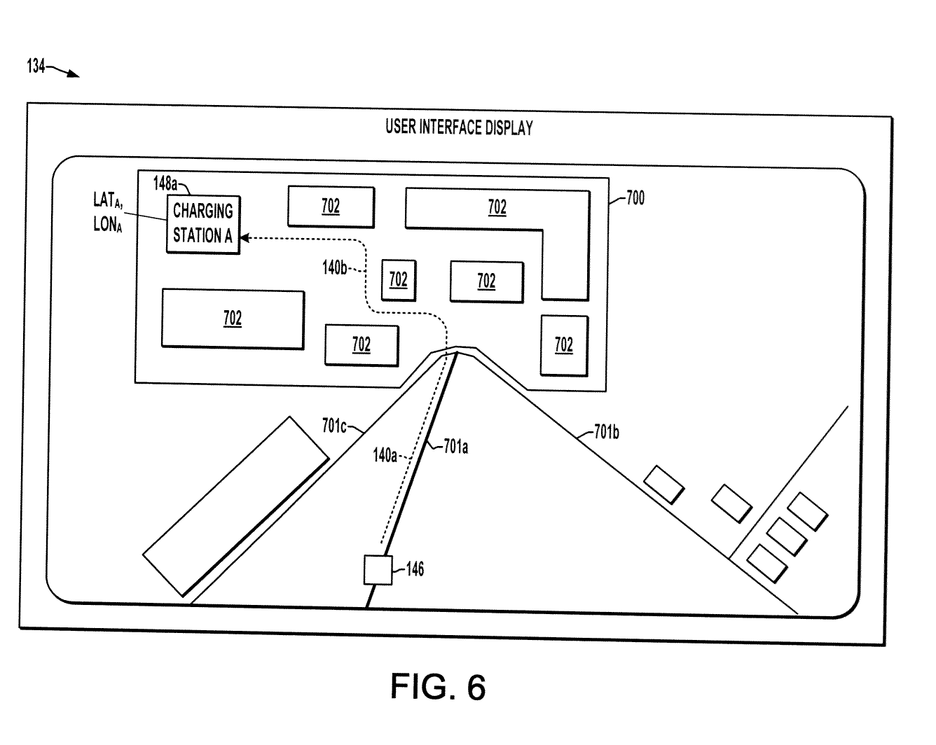

Referring also to FIG. 6, moreover, certain implementations of the navigation system 150 determine the route 140 to the destination location 148 at 370 using latitude and longitude information LAT_{A}, LON_{A} from the charging station data 162 for the selected charging station(s) 202. FIG. 6 illustrates a magnified street view on the display 134 as the vehicle 100 approaches the recommended charging station destination 148a, which is located in the grounds of a large shopping mall. It is noted in this example that the charging station destination 148a is not visible from the street entrance to the mall parking lot, and thus normal routing along a first route portion 140a according to destination street address (street driving) might leave the vehicle operator without any guidance from the street driveway entrance to the actual charging facility 202. This could potentially cause the vehicle 100 to run out of battery power while driving around the parking lot. Accordingly, the illustrated navigation system 150 continues providing driving directions (and map display indications) to route the driver along a further path 140b (parking lot routing) to the actual charging destination 148a using the latitude and longitude information LAT_{A}, LON_{A} from the charging station data 162.

The illustrated implementations include creation and maintenance of a real time charger station database 160 in the network server 210 of FIG. 2 that will be updated with the latest charger station information from individual stations 202. In certain implementations, moreover, a corresponding database (or a subset of the data contents of the database) can be stored on board the vehicle 100 as data store 152 in FIG. 1B, and this is updated by 2-way communications with a network database 160 to obtain the most current information regarding compatibility and charger availability/usage. Thus, whereas normal navigation point of interest (POI) data can be updated yearly, the live charging station database 152, 160 effectively facilitates intelligent routing for charging by including current availability information.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A battery electric vehicle, comprising:
a propulsion system, comprising:
a battery with a DC output,
an inverter with a DC input and an AC output, the inverter operative to convert DC power from the battery to provide AC electrical power to the AC output, and
an electric motor having an output shaft providing mechanical power to drive at least one wheel for propelling the vehicle using AC power generated by the inverter; and
a navigation system operative to obtain charging station data from a data store, to determine at least one selected charging station having charging equipment that is compatible with the vehicle and is currently available or expected to be available for charging the vehicle based at least in part on the charging station data and on a present state of charge value indicating a remaining amount of energy stored in the battery, and to determine a route for the vehicle extending from a current vehicle location to a destination location corresponding to the at least one selected charging station based at least in part on the charging station data and on the present state of charge value.

2. The battery electric vehicle of claim 1, where the navigation system is operative to obtain the charging station data from an external data store via wireless communications apparatus of the vehicle.

3. The battery electric vehicle of claim 2, where the navigation system is operative to obtain charging station data from the data store for a set of one or more in-range charging stations within range of the vehicle based at least in part on the present state of charge value, to determine a set of one or more compatible in-range charging stations in the set of in-range charging stations having charging equipment compatible with the vehicle based at least in part on the charging station data, to determine a set of one or more available compatible in-range charging stations in the set of compatible in-range charging stations that is currently available or expected to be available for charging the vehicle based at least in part on the charging station data, and to determine the at least one selected charging station as one or more of the charging stations in the set of available compatible in-range charging stations.

4. The battery electric vehicle of claim 3, where the navigation system is operative to obtain usage data from the charging station data including a charge start time and a charging vehicle current SOC value for compatible charger equipment for charging stations in the set of compatible in-range charging stations and to determine an availability of each compatible charger as one of available now, available soon, or unavailable based at least in part on the usage data.

5. The battery electric vehicle of claim 4, where the navigation system is operative to determine the route to the destination location using latitude and longitude information from the charging station data for the at least one selected charging station.

6. The battery electric vehicle of claim 3, where the navigation system is operative to determine the route to the destination location using latitude and longitude information from the charging station data for the at least one selected charging station.

7. The battery electric vehicle of claim 2, where the navigation system is operative to obtain usage data from the charging station data including a charge start time and a charging vehicle current SOC value for compatible charger equipment and to determine an availability of each compatible charger as one of available now, available soon, or unavailable based at least in part on the usage data.

8. The battery electric vehicle of claim 7, where the navigation system is operative to determine the route to the destination location using latitude and longitude information from the charging station data for the at least one selected charging station.

9. The battery electric vehicle of claim 1, where the navigation system is operative to obtain charging station data from the data store for a set of one or more in-range charging stations within range of the vehicle based at least in part on the present state of charge value, to determine a set of one or more compatible in-range charging stations in the set of in-range charging stations having charging equipment compatible with the vehicle based at least in part on the charging station data, to determine a set of one or more available compatible in-range charging stations in the set of compatible in-range charging stations that is currently available or expected to be available for charging the vehicle based at least in part on the charging station data, and to determine the at least one selected charging station as one or more of the charging stations in the set of available compatible in-range charging stations.

10. The battery electric vehicle of claim 9, where the navigation system is operative to obtain usage data from the charging station data including a charge start time and a charging vehicle current SOC value for compatible charger equipment for charging stations in the set of compatible in-range charging stations and to determine an availability of each compatible charger as one of available now, available soon, or unavailable based at least in part on the usage data.

11. The battery electric vehicle of claim 9, where the navigation system is operative to determine the route to the destination location using latitude and longitude information from the charging station data for the at least one selected charging station.

12. The battery electric vehicle of claim 1, where the navigation system is operative to obtain usage data from the charging station data including a charge start time and a charging vehicle current SOC value for compatible charger equipment and to determine an availability of each compatible charger as one of available now, available soon, or unavailable based at least in part on the usage data.

13. The battery electric vehicle of claim 12, where the navigation system is operative to determine the route to the destination location using latitude and longitude information from the charging station data for the at least one selected charging station.

14. The battery electric vehicle of claim 1, where the navigation system is operative to determine the route to the destination location using latitude and longitude information from the charging station data for the at least one selected charging station.

15. A method for determining a route for a battery electric vehicle, the method comprising:
obtaining a present state of charge value indicating a remaining amount of energy stored in the battery;
obtaining a current vehicle location;
obtaining charging station data from a data store;
determining at least one selected charging station having charging equipment that is compatible with the vehicle and is currently available or expected to be available for charging the vehicle based at least in part on the charging station data and on the present state of charge value; and
determining a route for the vehicle extending from the current vehicle location to a destination location corresponding to the at least one selected charging station based at least in part on the charging station data and on the present state of charge value.

16. The method of claim 15, comprising obtaining the charging station data from an external data store via wireless communications apparatus of the vehicle.

17. The method of claim 15, comprising:
obtaining charging station data from the data store for a set of one or more in-range charging stations within range of the vehicle based at least in part on the present state of charge value;
determining a set of one or more compatible in-range charging stations in the set of in-range charging stations having charging equipment compatible with the vehicle based at least in part on the charging station data;
determining a set of one or more available compatible in-range charging stations in the set of compatible in-range charging stations that is currently available or expected to be available for charging the vehicle based at least in part on the charging station data; and
determining the at least one selected charging station as one or more of the charging stations in the set of available compatible in-range charging stations.

18. The method of claim 17, comprising:
obtaining usage data from the charging station data including a charge start time and a charging vehicle current SOC value for compatible charger equipment for charging stations in the set of compatible in-range charging stations; and
determining an availability of each compatible charger as one of available now, available soon, or unavailable based at least in part on the usage data.

19. The method of claim 15, comprising:
obtaining usage data from the charging station data including a charge start time and a charging vehicle current SOC value for compatible charger equipment; and
determining an availability of each compatible charger as one of available now, available soon, or unavailable based at least in part on the usage data.

20. The method of claim 15, comprising determining the route to the destination location using latitude and longitude information from the charging station data for the at least one selected charging station.
